(19) United States
(12) Patent Application Publication
(10) Pub. No.: US 2007/0132589 A1
(43) Pub. Date: Jun. 14, 2007

(54) System and method for managing postal devices using radio frequency identification

(75) Inventors: Sung Wook Kim, Daejeon (KR); Sung Whan Choi, Daejeon (KR); Jong Heung Park, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics & Telecommunications Research Institute

(21) Appl. No.: 11/635,201

(22) Filed: Dec. 7, 2006

(30) Foreign Application Priority Data
Dec. 8, 2005 (KR) 10-2005-119376
Jun. 16, 2006 (KR) 10-2006-54421

(51) Int. Cl. G06F 17/00

(52) U.S. Cl. 340/572.1; 705/401

(57) ABSTRACT

A system and method for processing postal work using Radio Frequency Identification (RFID) apparatus. With RFID applied to the postal work, the system includes a structure for managing postal devices used in postal registration center and postal delivery center such as embedded controllers for controlling monitors, audio alarms, alarm lamps and PDAs. The system also includes middleware for managing RFID readers and message repeater adopting Java Messaging Service (JMS) . This allows exchanging data received from the RFID reader by JMS transfer method, ensuring stable asynchronous exchange of information and effective monitoring of data transferred in an entire process of postal work. This also decreases the load of the middleware in a work environment where a large amount of data is received in a short period of time such as postal work process.

### CLAIM OF PRIORITY

This application claims the benefit of Korean Patent Application No. 2005-119376 filed on Dec. 8, 2005, and Korean Application No. 2006-54421 filed on Jun. 16, 2006, in the Korean Intellectual Property Office, the disclosure of which is incorporated herein by reference.

### BACKGROUND OF THE INVENTION

1. Field of the Invention

The present invention relates to a system and a method for managing postal devices and, more particularly, to a system and a method for managing postal devices by monitoring connection status and message transmissions of the postal devices using Radio Frequency Identification (RFID) technology.

2. Description of the Related Art

In general, Radio Frequency Identification (hereinafter, referred to as ‘RFID’) has been gaining attention as a means for connecting an object to a computer. RFID refers to a medium for exchanging data through an antenna by use of an IC chip having an identification for identifying radio frequency.

An RFID tag, a technology which stores information ranging from production to sales in an ultra-small IC chip and utilizes the stored information for short range wireless communication, Internet, satellites and mobile communication networks, is referred to as a next-generation technology that can replace barcodes. In general, an RFID tag refers to a passive tag without a power source, which is differentiated from an active tag that has a power source or a CPU.

However, in terms of functional aspects of storing data or exchanging information, a passive RFID tag is no different from an active RFID tag.

In a passive RFID system, an RFID reader/writer transmits a RFID carrier signal to an RFID tag. Upon receiving the RF signal, the RFID tag modulates the amplitude or phase of the signal and transmits the data stored in the RFID tag to the reader as a carrier frequency signal. The returned modulated signal is decrypted and the RFID tag information is interpreted by the reader which is operated in connection with a PC or the Internet. The information received by the reader is used for regulating the RFID system by use of operation software for application purpose.

RFID is a non-contact identification system in which small chips (or tags) are attached to various products to transmit and process information on the product and the surrounding environment through radio frequency. Such a system is very effective for processing a large-capacity operation such as postal service.

Therefore, there have been active efforts recently to develop a system applying the RFID technology to barcode type of postal service in the post office to systematically and conveniently process the postal work at high speed.

### SUMMARY OF THE INVENTION

The present invention has been made to solve the foregoing problems of the prior art and therefore an aspect of the present invention is to provide a system and a method for managing postal devices, in which Radio Frequency Identification (RFID) technology is applied to monitor and manage postal devices and a large amount of data generated from postal work.

Another aspect of the invention is to provide a system and a method for managing postal devices, which ensure safe and secure data transfer during message exchange between the postal devices by applying Java Messaging Service to the postal work adopting RFID technology.

According to an aspect of the invention, the invention provides a system for managing postal devices using Radio Frequency Identification (RFID). The system includes: at least one application manager connected to at least one postal device to receive and manage information therefrom, convert a message received from the connected postal device into a first Java Messaging Service (JMS) message, and transmit the first JMS message; at least one middleware connected to at least one RFID reader to receive and manage information therefrom, convert a message received from the connected RFID reader into a second JMS message, and transmit the second JMS message to the at least one application manager; a message repeater for repeating the JMS messages transmitted/received between the at least one application manager and the at least one middleware.

According to another aspect of the invention, the invention provides a method for managing postal devices using Radio Frequency Identification (RFID), by at least one application manager in a management system which includes the least one application manager connected to at least one postal device, at least one middleware connected to at least one RFID reader and a message repeater associated with the at least one application manager and the at least one middleware. The method includes: connecting to the postal device to manage received information; converting a message containing data transmitted from the connected postal device into a Java Messaging Service (JMS) message; and adding header and attributes to the JMS message and transmitting the message to the middleware.

The method further includes receiving result for the transmitted JMS message back from the RFID reader connected to the middleware.

According to further another aspect of the invention, the invention provides a method for managing postal devices using Radio Frequency Identification (RFID), by at least one middleware in a management system which includes at least one application manager connected to at least one postal device, the at least one middleware connected to at least one RFID reader and a message repeater associated with the at least one application manager and the at least one middleware. The method includes: receiving a first Java Messaging Service (JMS) message containing data received from the postal device connected to the at least one application manager; analyzing the received JMS message to transmit analysis result to the RFID reader; receiving information on the analysis result back from the RFID reader and analyzing the information on the analysis result; producing a second JMS message containing the information on the analysis result; and adding header and attributes to the second JMS message and transmitting the second JMS message to the at least one application manager.

The method further includes: connecting to the RFID reader; and storing and managing the information received from the connected RFID reader.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a system for managing postal devices according to an embodiment of the present invention;

FIG. 2 is a block diagram illustrating a structure of an application manager shown in FIG. 1;

FIG. 3 is a block diagram illustrating a structure of a middleware shown in FIG. 1;

FIG. 4 is a flowchart illustrating a process of message transmission by the application manager connected to the postal device in the system for managing postal devices according to an embodiment of the present invention;

FIG. 5 is a flowchart illustrating a process of processing data received from the application manager by the middleware in the system for managing a postal device according to an embodiment of the present invention; and

FIG. 6 is a flowchart illustrating a process of repeating a message between the application manager and a middleware in the system for managing a postal device according to an embodiment of the present invention.

### DETAILED DESCRIPTION OF THE PREFERRED EMBODIMENT

Exemplary embodiments of the present invention will now be described in detail with reference to the accompanying drawings. In the following description, the same reference numerals are used throughout the drawings to designate the same or similar components. Also, well-known functions and constructions are not described in detail since they would obscure the invention in unnecessary detail.

The present invention applies RFID technology to a system for postal work and relates to a system and a method for managing postal work devices (postal devices) which will be explained in the following description. To this end, there will be provided an explanation on monitoring the connection status and message transmission of the postal devices, storing the attributes of the postal devices, storing the attributes of RFID readers and monitoring the status of the RFID readers, and exchanging messages using Java Messaging Service (JMS) for stable data transfer.

First, the terms used in the present invention are defined as follows.

Extensible Markup Language (hereinafter, referred to as ‘XML’) is a text format designed for enabling transmission of structured documents on the Web. XML has been proposed as a solution for overcoming the limitation of the HyperText Markup Language (hereinafter, referred to as ‘HTML’) and for complementing the complexity of the Standard Generalized Markup Language (hereinafter, referred to as ‘SGML’), and has additional function over HTML, enabling a user to define a new tag. In addition, XML can be considered a subset of SGML since it has only the practical functions of SGML and thus is expected to be extensively utilized not only on the Internet but an extensive range of fields including electronic publishing, medicine, business administration, sales automation, digital library and electronic commerce. Moreover, XML provides a format readable from any platform, and thus is not restricted by a specific environment associated with a specific company product.

Java is a programming language designed especially for use in distributed Internet environment. Java looks much like C++, but is much easier to use and has enhanced object-oriented characteristics of programming. Java can be used for making an application program executed in a computer or in a distributed client/server environment in a network. It can also be used for making small application program modules or applets used for a part of a Web page. Here, the applets enable users to interact through the Web page.

A thread refers to information, related to each of the users, possessed by a program capable of simultaneously processing a plurality of users. From a perspective of the program, thread is the information necessary for providing a service to an individual user or granting a specific service request. If a plurality of users are using the program or requests were made simultaneously from other programs, thread is made and maintained for each of the users or the programs.

A middleware refers to a program that functions to mediate between or unite two programs separated in a computing environment. The most representative function of a middleware is allowing a program made for accessing a specific database to also access other databases. A recent application example of a middleware includes connecting between a database and a web server, thereby finding data from a database through a form displayed on a web browser or dynamically expressing the page according to the request of the user.

Now, a specific explanation will be provided on a system and a method for managing postal devices to process postal work using RFID according to an embodiment of the present invention, with reference to the accompanying drawings.

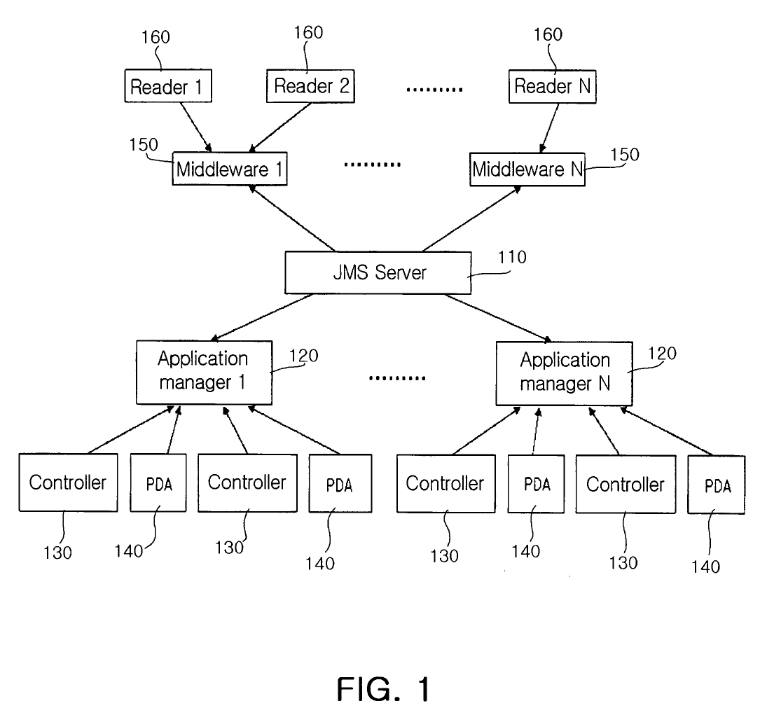

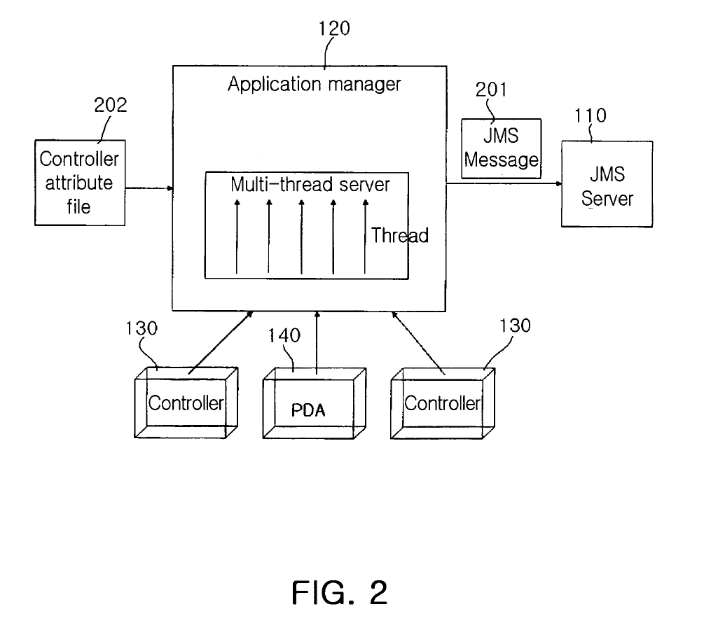

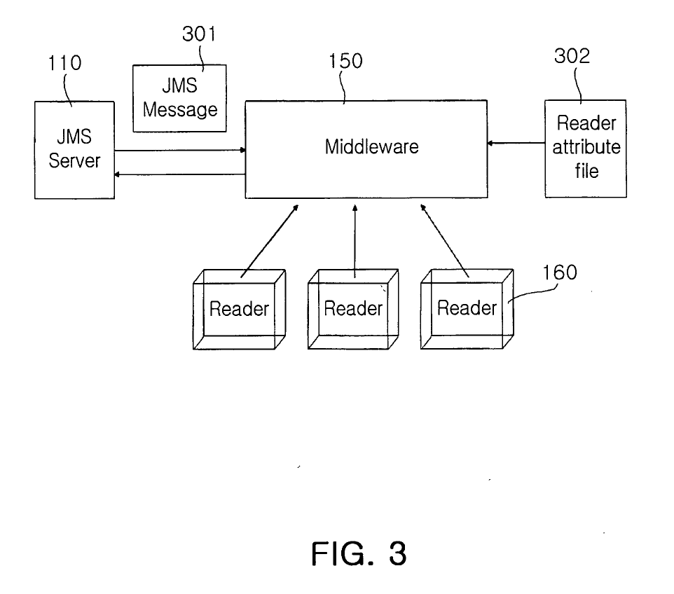

FIG. 1 is a block diagram illustrating a structure of a system for managing postal devices according to an embodiment of the present invention, FIG. 2 is a block diagram illustrating a detailed structure of an application manager shown in FIG. 1, and FIG. 3 is a block diagram illustrating a detailed structure of a middleware shown in FIG. 1.

Referring to FIG. 1, the system for managing postal devices includes a plurality of postal devices (controllers 130 and PDAs 140) to which information for managing postal work is inputted; application managers 120 for processing data received from the postal devices 130 and 140; a message repeater 110 for repeating messages to allow an apparatus connected to an RFID apparatus to interpret data received from the application managers 120, RFID readers 160 for reading a signal transmitted from the RFID apparatus where postal collection and management data is stored, and middlewares 150 for analyzing the signal transmitted from each of the readers 160 and sending the signal to the message repeater. Here, the message repeater 110 is a Java Messaging Service (JMS) server which repeats messages by receiving a message converted to a Java Messaging Service (JMS) type by the application manager, and adds a header and attributes to the message and transmits the message to the middleware 150. The message repeater 110 will be referred to as JMS server 110.

Such a system for managing postal devices is a software architecture with an extensible physical deployment, and with RFID applied to the postal work, is capable of checking and regulating the status of a plurality of controllers 130 installed at each component or PDAs used for delivery and adding the controllers 130 or PDAs 140 in real time.

Referring to FIG. 2, the application manager 120 uses attribute files (XML files) 202 of the postal devices 130 and 140 and produces a thread for managing each of the postal devices 130 and 140 when connected to the postal devices 130 and 140 through a multi-thread server 121. And the application manager 120 converts the message received from the postal devices 130 and 140 into a first Java Messaging Service (hereinafter, referred to as ‘JMS’) message 201 and transmits the first message to the JMS server 110. Here, the first JMS message 201 is transmitted to the middleware 150 using queue or topic (not shown) of the JMS server 120. And the attribute file 202 has Identification (ID), Internet Protocol (IP) and location information set for each of the postal devices 130 and 140.

Referring to FIG. 3, the middleware 150 receives a reader attribute file 302 with information received from the RFID readers 160. Here, the reader attribute file 302 has the attributes of the reader defined in advance in XML, and has identification (ID), Internet Protocol (IP) set for the reader 160 and identification (ID) set for the controller 130 corresponding to the particular reader 160. The middleware 150 receives a second JMS message 301 received via the JMS server 110 from the application manager 120 and parses and analyzes the second JMS message 301. The middleware 150 also determines which of the postal devices the second message 301 was transmitted from and uses the determination result to forward the information from the readers 160 to the application managers 120. Such a structure of the middleware 150 provides stable and high-quality messaging service, ensuring and effectively monitoring data delivery.

In addition, due to the characteristics of postal work with a large amount of data received in a short period of time, the middleware 150 monitors and refines postal work data and registers the data to the JMS server 110. The middleware 150 manages the postal work data as well as additional devices for the postal work, for example, monitors for sending commands to the RFID reader and displaying results and lamps and audio alarms for monitoring and alerting false arrivals.

Using Java Messaging Service, the JMS server 110 receives data and messages transmitted through the application managers 120 from the plurality of postal devices 130 and 140 as well as data and messages received through the middleware 150 from the readers 160 by use of queue or topic (not shown) of the JMS server 110. The JMS server 110 distinguishes from the heads of the messages which of the devices the messages are bound for.

The system for managing the postal devices may be configured as a part of a middleware, or at least one module of the system for managing postal devices may be managed by a middleware.

A command received from a user through a monitor (not shown) is transmitted, through an embedded controller 139 regulating the monitor, to the application manager 120 managing the embedded controller 130. The application manager 120 transmits the command back to the middleware 150 to deliver the command from the user to the RFID reader 160.

Now, a method of managing a postal device in the system for managing postal devices having the above described configuration according to the present invention will be explained in detail with reference to accompanying drawings. First, the operation of the application manager, which receives information from the postal devices and processes the information, will be explained with reference to the accompanying drawings.

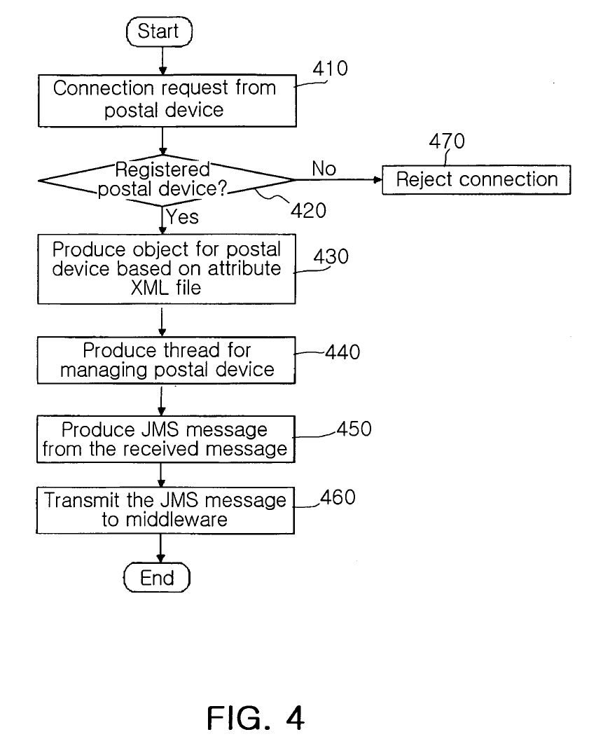

FIG. 4 is a flowchart illustrating a process of message transmission by the application manager when connected to the postal devices, in the system for managing postal devices according to a certain embodiment of the present invention.

Referring to FIG. 4, when a connection request is made from an arbitrary postal device in step 410, the application manager 120 determines whether the postal device had been registered or not in step 420. If the postal device had not been registered, the application manager 120 rejects the connection of the postal device in step 470.

If the postal device is approved as a registered one in step 420, the application manager 120 produces an object for the postal device based on an attribute file (XML file) of the postal device in step 430, and produces a thread for managing the connected postal device in step 440.

Thereafter, the application manager 120 converts a message received from the postal device into a JMS type message, i.e., produces a first JMS message in step 450. Then, the application manager 120 transmits the first JMS message to the middleware 150 through the JMS server 110 in step 460. The JMS server 110 serves a repeating function by adding a header and attributes to the first JMS message received from the application manager 120 and transmitting a second JMS message to the middleware 150.

Then, the middleware 150 processes the data contained in the second JMS message received as above. The operation of the middleware 150 will be explained hereunder with reference to accompanying drawings.

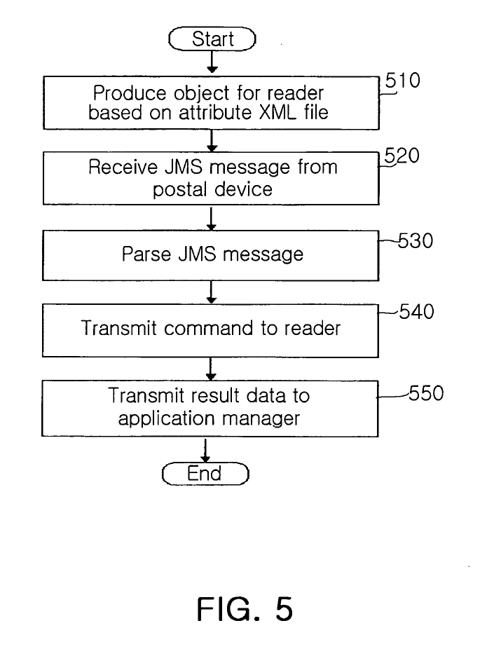

FIG. 5 is a flowchart illustrating the middleware processing the data received from the application manager in the system for managing a postal device according to a certain embodiment of the present invention.

Referring to FIG. 5, the middleware 150 produces an object for an arbitrary reader 160 based on an attribute file (XML file) in step 510 and receives the first JMS message from the application manager 120 in step 520. Then, the middleware 150 parses the first JMS message in step 530 and transmits the command to the reader 160 in step 540 and transmits the result data to the application manager 120 in step 550.

Now, a process of repeating messages between the middleware and the application manager operating as described above will be explained with reference to the accompanying drawings.

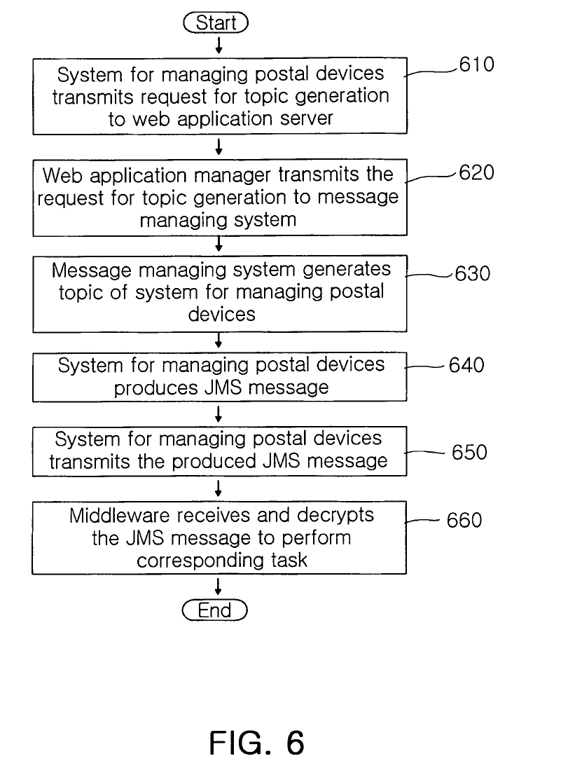

FIG. 6 is a flowchart illustrating a process of repeating messages between the application manager and the middleware in the system for managing postal devices according to the present invention.

Referring to FIG. 6, since the message transmission between the application manager and the middleware takes place on the basis of queue or topic of the JMS server 110, the system for managing postal devices requests a web application server (not shown) to generate topic in step 610. Thereby, the web application server sends the request to a message managing system (not shown) provided in a communication network in step 620, and thus the message managing system generates topic of the system for managing the postal devices in step 630.

In step 640, the system for managing postal devices produces a first JMS message by the application manager 120 and transmits the first JMS message to the middleware 150 in step 650. Thereby, the middleware 160 receives and decrypts the first JMS message from the application manager 110 and performs the corresponding operation in step 660.

According to the present invention set forth above, data from the RFID reader is exchanged by JMS transmission method, ensuring stable exchange of information transmitted asynchronously and stable monitoring of data transferred in the entire postal work process. In addition, the present invention allows decreasing the load of the middleware in an environment where a large amount of data is received, such as the postal work process.

While the present invention has been shown and described in connection with the exemplary embodiments, it will be apparent to those skilled in the art that modifications and variations can be made without departing from the spirit and scope of the invention as defined by the appended claims.

What is claimed is:

1. A system for managing postal devices using Radio Frequency Identification (RFID), comprising:
at least one application manager connected to at least one postal device to receive and manage information therefrom, convert a message received from the connected postal device into a first Java Messaging Service (JMS) message, and transmit the first JMS message;
at least one middleware connected to at least one RFID reader to receive and manage information therefrom, convert a message received from the connected RFID reader into a second JMS message, and transmit the second JMS message to the at least one application manager;
a message repeater for repeating the JMS messages transmitted/received between the at least one application manager and the at least one middleware.

2. The system according to claim 1, wherein the at least one middleware analyzes the first JMS message received from the at least one application manager to transmit analysis result to the corresponding RFID reader, receives result information back from the RFID reader, and produces and transmits the second JMS message containing the result information to the application manager.

3. The system according to claim 1 or 2, wherein the middleware is adapted to parse the first JMS message transmitted from the application manager and analyzes attributes of data received from the postal device.

4. The system according to claim 1, wherein the at least one application manager is adapted to be connected to the at least one postal device, utilizes an attribute file of the postal device to generate an object for the postal device, and produces a thread for managing the postal device.

5. The system according to claim 4, wherein the attribute file of the postal device is set in advance in the form of an Extensible Markup Language (XML) containing an Identification (ID), Internet Protocol (IP) and location information set for the postal device.

6. The system according to claim 1, wherein the message relaying unit is adapted to repeat the JMS messages transmitted/received between the at least one application manager and the at least one middleware, and transmits the JMS messages using queue or topic of the Java Messaging Service.

7. A method of managing postal devices using Radio Frequency Identification (RFID), by at least one application manager in a management system which includes the least one application manager connected to at least one postal device, at least one middleware connected to at least one RFID reader and a message repeater associated with the at least one application manager and the at least one middleware,
the method comprising:
connecting to the postal device to manage received information;
converting a message containing data transmitted from the connected postal device into a Java Messaging Service (JMS) message; and
adding header and attributes to the JMS message and transmitting the message to the middleware.

8. The method according to claim 7, further comprising receiving result for the transmitted JMS message back from the RFID reader connected to the middleware.

9. The method according to claim 7, wherein the connecting to the postal device to manage received information comprises:
receiving a connection request from the postal device;
checking registration of the postal device;
producing an object for the postal device using an attribute file of the postal device if the postal device is registered; and
producing a thread for managing the connected postal device.

10. The method according to claim 9, wherein the attribute file of the postal device is set in advance in the form of an Extensible Markup Language (XML) containing an Identification (ID), Internet Protocol (IP) and location information set for the postal device.

11. The method according to claim 7, wherein the message repeater is adapted to repeat the JMS messages transmitted/received between the at least one application manager and the at least one middleware, and transmits the JMS messages using queue or topic of the Java Messaging Service.

12. A method of managing a postal device using Radio Frequency Identification (RFID), by at least one middleware in a management system which includes at least one application manager connected to at least one postal device, the at least one middleware connected to at least one RFID reader and a message repeater associated with the at least one application manager and the at least one middleware,
the method comprising:
receiving a first Java Messaging Service (JMS) message containing data received from the postal device connected to the at least one application manager;
analyzing the received JMS message to transmit analysis result to the RFID reader;
receiving information on the analysis result back from the RFID reader and analyzing the information on the analysis result;
producing a second JMS message containing the information on the analysis result; and
adding header and attributes to the second JMS message and transmitting the second JMS message to the at least one application manager.

13. The method according to claim 12, further comprising:
connecting to the RFID reader; and
storing and managing the information received from the connected RFID reader.

14. The method according to claim 13, wherein the connecting to the RFID reader comprises:
receiving a connection request from the RFID reader;
checking registration of the RFID reader and accepting or rejecting the connection request according to the checking result; and
producing an object for the RFID reader using an attribute file of the RFID reader if the connection request is accepted.

15. The method according to claim 14, wherein the attribute file of the postal device is set in advance in the form of an Extensible Markup Language (XML) containing an Identification (ID), Internet Protocol (IP) and location information set for the postal device.

16. The method according to claim 12, wherein the message repeater is adapted to repeat the JMS message transmitted/received between the at least one application manager and the at least one middleware, and transmits the JMS message using queue or topic of the Java messaging service.
